(19) United States
(12) Patent Application Publication
(10) Pub. No.: US 2017/0273504 A1
(43) Pub. Date: Sep. 28, 2017

(54) Automated Cooker

(71) Applicant: Peigen Jiang, Sammamish, WA (US)

(72) Inventor: Peigen Jiang, Sammamish, WA (US)

(21) Appl. No.: 15/081,947

(22) Filed: Mar. 28, 2016

(51) Int. Cl. A47J 36/16; H05B 6/06; H05B 6/12; A47J 27/00; A47J 36/10

(52) U.S. Cl. CPC A47J 36/165; A47J 27/004; A47J 36/10; H05B 6/1227; H05B 6/062

(57) ABSTRACT

An automated cooking system is disclosed which includes a wok for receiving food and heat, a stirrer capable of making swing and rotating motions in the wok, a sensor placed in the wok for measuring ambient data, a base unit housing a heating element for heating up the wok, the base unit also housing a controller for operating the heating element, the stirrer's swing and rotating motions and the sensor, and a computing device physically separated from the base unit yet signally coupled to the controller, the computing device storing a recipe which instructs the computing device to obtain the ambient data from and send operating commands to the controller.

### BACKGROUND

The present invention relates generally to cooking apparatus, and, more particularly, to an automated cooking system and method.

Home meal cooking has traditionally been a manual operation, i.e., cooking time, temperature and occasional stirring of food in a cooking utensil are determined and implemented by a human operator. Such traditional way of cooking is not only labor intensive, but also heavily rely on operators' experience to make a good meal.

Even though cooking recipes have been widely available, they mostly emphasize on ingredients and not much on the art of actual heating the food.

As such, what is desired is a system and method that can automate much of the cooking process and provide a platform for people to share such automated cooking process.

### BRIEF DESCRIPTION OF THE DRAWING

FIG. 1 illustrates an automated cooking system according to an embodiment of the present invention.

FIGS. 2A and 2B illustrate details of an automated cooker shown in FIG. 1.

FIG. 3 illustrates an exemplary fixture for restraining the lid of the automated cooker shown in FIG. 2.

FIG. 4 illustrates a stirrer driving mechanism.

FIG. 5 is a block diagram illustrating electronic components of automated cooking system shown in FIG. 1.

FIG. 6 illustrates an exemplary temperature profile of a recipe displayed on the tablet computer.

The drawings accompanying and forming part of this specification are included to depict certain aspects of the invention. A clearer conception of the invention, and of the components and operation of systems provided with the invention, will become more readily apparent by referring to the exemplary, and therefore non-limiting, embodiments illustrated in the drawings, wherein like reference numbers (if they occur in more than one view) designate the same elements. The invention may be better understood by reference to one or more of these drawings in combination with the description presented herein.

### DESCRIPTION

The present invention relates to an automated cooking system and method. A preferred embodiment of the present invention will be described hereinafter with reference to the attached drawings.

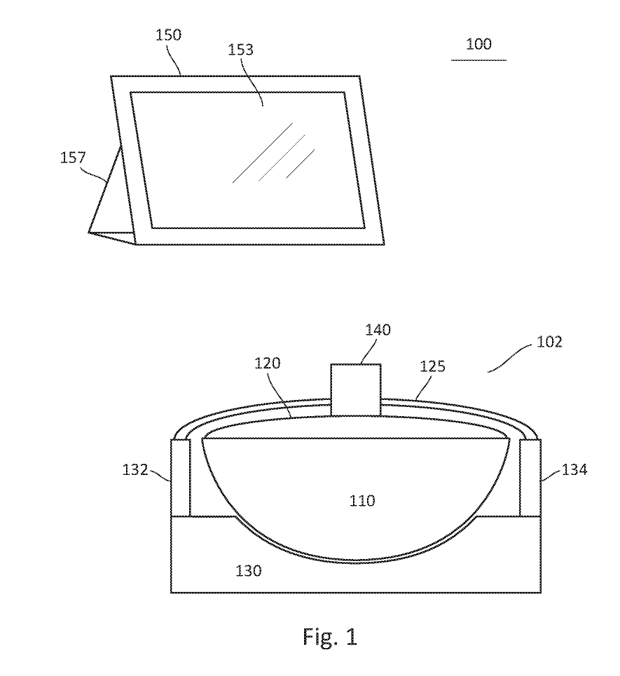

FIG. 1 illustrates an automated cooking system 100 according to an embodiment of the present invention. The automated cooking system 100 includes an automated cooker 102 and a tablet computer 150. The tablet computer 150 wirelessly communicates with the automated cooker 102 to function as a remote controller and monitor as well as a cooking process programming device. The tablet computer 150 is of a common type having a touch display 153 and a stand 157. In other embodiments, a laptop or a desktop or even a dedicated computing device with at least a processing unit and a storage can be used in place of the tablet computer 150

Referring again to FIG. 1, the automated cooker 102 includes a wok 110 with a lid 120, a base unit 130 and a stirrer actuator 140 mounted on the lid 120. In a preferred embodiment, the base unit 130 uses inductive effect to generate heat in the wok 110. In addition, a bar 125 is attached to the stirrer actuator 140. One end of the bar 125 rests on a left riser 132, and the other end of the bar 125 rests on a right riser 134. The left riser 132 and the right riser 134 exemplarily protrude from the base unit 130. Alternatively, the ends of the bar 125 can be extended downward to reach the base unit without any protruding member from the base unit 130. In embodiments, power supply and control unit are housed in the base unit 130. In order to supply power and conduct control signals to the stirrer actuator 140, electrical contacts (not shown) are provided on an end of the bar 125 and on top of one of the risers 132 and 134, so that when the bar 125 rests on the risers 132 and 134, electrical connections are made between the two parts. Then the bar 125 serves as a conduit to hide electrical wires connecting the stirrer actuator to the base unit 130.

Referring again to FIG. 1, the bar 125 is separated from the lid 120 to avoid being heat up during cooking. However, when the bar 125 is made with a heat resistive material such aluminum, the bar 125 can come into contact with or even be part of the lid 120.

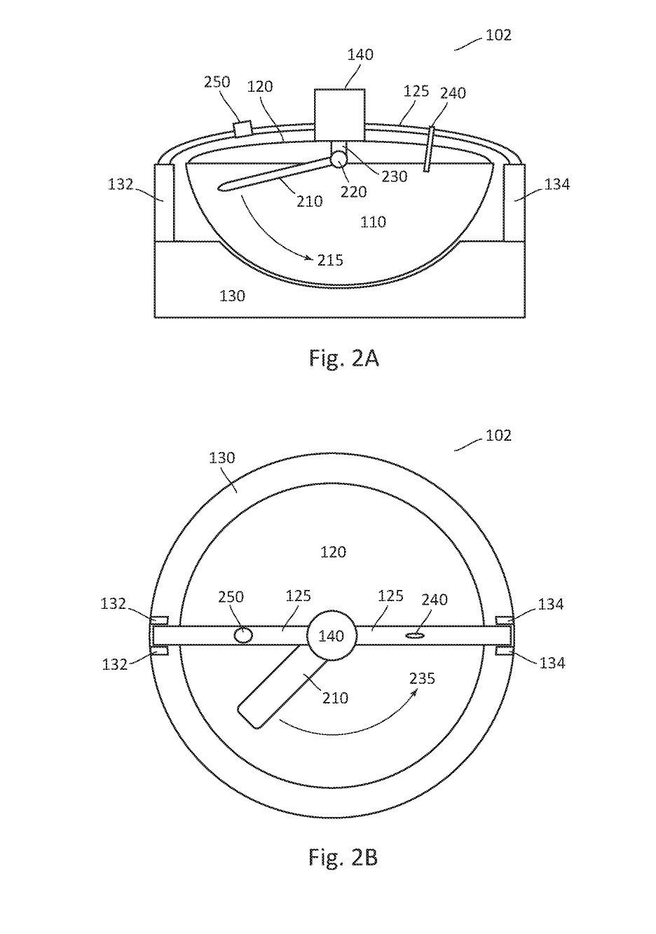

FIGS. 2A and 2B illustrates details of the automated cooker 102 shown in FIG. 1. Referring to FIG. 2A, the automated cooker 102 further includes a stirrer 210 coupled to the stirrer actuator 140 which drives the stirrer 210 to make swing motion around a horizontal shaft 220 which is coupled to the stirrer actuator 140 through a vertical shaft 230. Referring to both FIGS. 2A and 2B, the stirrer 210, along with the horizontal shaft 220 and the vertical shaft 230, are driven by the stirrer actuator 140 to rotate around the stationary stirrer actuator 140. The stirrer 210's swing and rotating motion can stir food (not shown) inside the wok 110 during cooking. The swing and rotating speeds can be adjusted based on characteristics of the food under cooking. For the same reason, the stirrer 210 is replaceable. For thicker food, the stirrer 210 may have a thinner blade; while for lighter food, such as leafy vegetables, the stirrer 210 may have a wider blade. In addition, the blade of the stirrer 210 may form an oblique angle (not shown), which is adjustable, to the plane in which the stirrer 210 swings.

Referring again to FIGS. 2A and 2B, a temperature sensor 240 is mounted on the bar 125 with a probe reaching into the wok 110. Ambient temperature data is then relayed to a controller inside the base unit 130 via wires hidden inside the bar 125 and the riser 132 or 134. Similarly, an image sensor 250 can also be mounted on the bar 125 for periodically taking images of the content in the wok 110. The images are also transmitted to the controller inside the base unit 130. In embodiments, a smell sensor (not shown) may also been installed. The smell sensor may detect a burn and immediately shut off the automated cooking system.

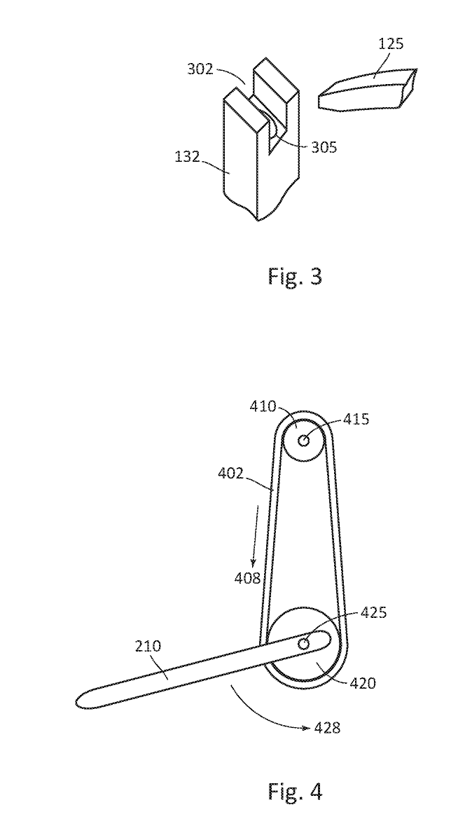

Referring again to FIG. 2B, risers 132 and 134 prevent the bar 125 from rotating relative to the base unit 130, so that the lid 120 and the stirrer actuator 140 remain stationary when the stirrer 210 swings and rotates. Such feature is further depicted in FIG. 3.

FIG. 3 illustrates an exemplary fixture for restraining the lid 120 of the automated cooker 102 shown in FIG. 2. The fixture includes a notch 302 formed on top of the riser 120. When an end of the bar 125 falls into the notch 302, movement of the bar 125 will be restricted. Similarly, the riser 134 also has such a notch (not shown) for restricting the other end of the bar 125.

Referring again to FIG. 3, an exemplary conductive terminal 305 is provided at a bottom of the notch 302. There is a corresponding conductive terminal (not shown) on a bottom surface of the bar 125, so that when the bar 125 is placed in the notch 302, the conductive terminals come into contact to make a connection between a wire in the riser 132 and a wire in the bar 125 for conducting electricity or control signal. In other embodiments, multiple conductive terminals, if needed, can be provided at the bottom or on a side of the notch 302.

FIG. 4 illustrates a stirrer driving mechanism. The stirrer 210 is attached to a first pulley 420, which can rotate around a first axis 425. Above the first pulley 420, there is a second pulley 410 driven by an electrical motor (not shown) to rotate around a second axis 415. The first and second pulleys 420 and 410 are linked by a belt 402. When the second pulley 410 rotates counter clockwise, the belt 402 will move in a direction 408 and cause the first pulley 420 to also rotate counter clockwise. As a result, the stirrer 210 will swing in direction 428. In a next cycle, the stirrer 210 swings in a direction opposite to the direction 428. As the first pulley 420 and the belt 402 are located below the lid 120, they have to be made with heat resistive materials. In embodiments, the first pulley 420 may be made from stainless steel, and the belt 402 may be made from Polytetrafluoroethylene (PTFE) or commonly known as Teflon. As the second pulley 410 is located above the lid 120, it along with the electrical motor will not be exposed to excessive heat, so that they can be made with ordinary materials. In order to better engage the pulleys 410 and 420 with the belt 402, corresponding teeth may be provided to surfaces of the pulleys 410 and 420 and the belt 402.

Referring to both FIGS. 2 and 4, the first axis 425 may be equivalent to the horizontal shaft 220. The belt 402 may be housed in the vertical shaft 230 to which the first axis 425 and the second axis 415 are secured. A motor and gear system (not shown) which is mounted to a shell of the stirrer actuator 140 can drive the vertical shaft 230 to rotate in a horizontal plane.

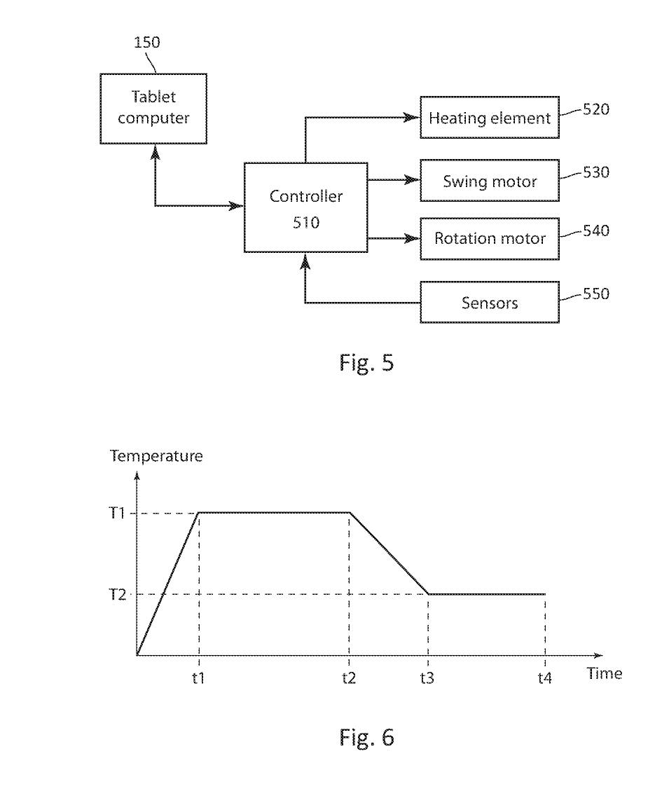

FIG. 5 is a block diagram illustrating electronic components of automated cooking system 100 shown in FIG. 1. The automated cooking system 100 includes the tablet computer 150 and a controller 510 which controls a heating element 520, a swing motor 520 and a rotation motor 530. The heating element 520 is housed in the base unit 130 and may be of inductive type. The swing motor 520 drives the swing motion of the stirrer 210. The rotation motor 530 drives the horizontal rotating motion of the stirrer 210. In addition, one or more sensors 550 can be connected to the controller 510. Sensors 550 may include temperature sensing, image capturing, smell detection and weight measurement. The controller 510 is then coupled to the tablet computer 150 either wirelessly or wired, and receives commands from and transmits sensed data to the tablet computer 150.

In operation, the tablet computer 150 may store one or more cooking recipes which determines various cooking parameters such as temperature target, heating timing and duration, and speeds and timing of stirrer's swing and rotation, etc. Upon an initiation of a recipe, the tablet computer 150 sends commands to the controller 510 to turn on the heating element 520 as well as turns on the swing motor 530 and rotation motor 540 after a predetermined period of time following the turn-on of the heating element 520. In the beginning, speeds of the stirrer swing and rotation may be slow and gradually increase over time. The controller 510 may also activate the sensors 550 to periodically sample the ambient data such as temperature. Once a predetermined cooking time is reached, the tablet computer 150 sends a command to the controller 510 to turn off everything and at the same time produces a reminder, such as sound, to signal the completion of the cooking. Alternatively, the tablet computer 150 may command the controller 510 to reduce heat and turn off the swing motor 530 and the rotation motor 540. In such a way, the automated cooking system 100 can keep the food warm after the cooking. During the keeping-warm period, the tablet computer 150 keeps measuring the temperature and controllably operates the heating element 520 to maintain a desired temperature. The tablet computer 150 may also control a weight sensor (not shown) situated beneath the wok 110 to monitor the weight of the wok 110. Once the weight is below a predetermined level signally a removal of the food, the heating element 520 is turned off as well.

FIG. 6 illustrates an exemplary temperature profile of a recipe that is displayed on the tablet computer 150. At time t1, the measured temperature is controlled to reach temperature T1, which is maintained until time t2. At time t3, temperature value is allowed to drop to T2 which is then maintained until t4. As FIG. 6 illustrates, the automated cooking system 100 can finely adjust a cooking process in terms of temperature, duration and stirring with the control of the tablet computer 150. Similarly, stirring speed and timing parameters can also be display on the tablet computer 150.

A recipe can be downloaded from the Internet or developed with the automated cooking system 100. Developing a recipe is an empirical process, a user first manually operates the automated cooking system 100 by manually setting parameters such as temperature and stirring speed and timing and by physically observing the cooking effect. Once a desired result is achieved, the set of parameters can then be stored in a new recipe in the tablet computer 150. The new recipe can be used to automatically control a future cooking process, and can also be shared with others over the Internet. In order to facilitate recipe trading, a market place can be formed over the Internet for recipe developers and buyers to meet. Once a recipe is purchased and downloaded to the tablet computer 150, a cooking process specified by the purchased recipe can be exactly duplicated at the automated cooking system 100.

While this disclosure has been particularly shown and described with references to exemplary embodiments thereof, it shall be understood by those skilled in the art that various changes in form and details may be made therein without departing from the spirit of the claimed embodiments.

What is claimed is:

1. A cooking system comprising:
a wok for receiving food and heat;
a stirrer capable of making swing and rotating motions in the wok;
a sensor placed in the wok for measuring ambient data;
a base unit housing a heating element for heating up the wok, the base unit also housing a controller for operating the heating element, the stirrer's swing and rotating motions and the sensor; and
a computing device physically separated from the base unit yet signally coupled to the controller, the computing device storing a recipe which instructs the computing device to obtain the ambient data from and send operating commands to the controller.

2. The cooking system of claim 1, wherein the stirrer's swing motion is in a vertical plane and the stirrer's rotating motion is in a horizontal plane.

3. The cooking system of claim 1, wherein the stirrer's swing motion is driven by a belt system.

4. The cooking system of claim 1, wherein the stirrer's rotating motion is driven by a gear system.

5. The cooking system of claim 1, wherein the stirrer has a removable and angle adjustable blade.

6. The cooking system of claim 1 further comprising a lid for covering the wok and for securing the stirrer.

7. The cooking system of claim 6, wherein the lid is maintained stationary relative to the base unit during cooking.

8. The cooking system of claim 1, wherein the sensor measures temperature.

9. The cooking system of claim 1, wherein the sensor detects smell.

10. The cooking system of claim 1, wherein the heating element is of an inductive type.

11. The cooking system of claim 1, wherein the computing device is wirelessly coupled to the controller.

12. The cooking system of claim 1, wherein the computing device takes the ambient data into account before sending the operating commands.

13. The cooking system of claim 1, wherein the computing device is capable of entering parameters into a recipe, the parameters determining the controller's operation of the heating element, the stirrer's swing and rotating motions and the sensor.

14. The cooking system of claim 1, wherein the computing device is connected to the Internet and capable of downloading and uploading recipes.

15. The cooking system of claim 14 further comprising a recipe market place on the Internet for trading recipes.

16. The cooking system of claim 14 further comprising an image sensor for capturing image of content in the wok.

17. The cooking system of claim 1, wherein the heating element, the stirrer's swing and rotating motions and the sensor can be manually operated.
